(19) United States
(12) Patent Application Publication
(10) Pub. No.: US 2005/0102159 A1
(43) Pub. Date: May 12, 2005

(54) Computer based risk level monitor and patient compliance method and system

(76) Inventor: Robert B. Mondshine, Bal Harbor, FL (US)

Correspondence Address: ROBERT C. KAIN, JR., 750 SOUTHEAST THIRD AVENUE, SUITE 100, FT LAUDERDALE, FL, 333161153, US

(21) Appl. No.: 10/704,172

(22) Filed: Nov. 6, 2003

(51) Int. Cl. G06F 17/60

(52) U.S. Cl. 705/2

(57) ABSTRACT

The risk monitor, as a computer-based method, program or system, monitors medical compliance by a plurality of patients having a corresponding plurality of medical compliance plans. The plans for each patient are displayed and the system accepts input from the patient indicative and/or heathcare providers of the patient's compliance with the plan. The system then assesses or analyzes the input and assigns a corresponding risk value based upon a range of risk values for various degrees of compliance. In addition, the patient's lifestyle inputs can be added to determine the risk value. The assessment continues for a plurality of patients thereby providing an indication of the risk value (a total risk value) for a patient, doctor, group of healthcare providers, a clinic or a hospital. By implementing various communication episodes (telephone calls, e-mails, letters), the system seeks to reduce the risk value for a particular patient and for the plurality of patients by altering the communication episodes and monitoring the resulting risk values both individually and as a group.

The present invention relates to a computer based method and system for monitoring patient compliance and determining a risk level, both on an individual basis and on a collective basis (for a plurality of patients).

### BACKGROUND OF THE INVENTION

Surprisingly, a high percentage of prescribed pharmaceuticals in the United States are not consumed by patients who are required to consume the drugs. Estimates of improper or inadequate use range between 25-50%. The failure to take medication as directed by a physician is termed “non-compliance” and is a well identified patient behavior, and of growing concern within the health care community. The National Pharmaceutical Council estimates non-compliance costs more than 100 billion dollars annually due to increased hospital admissions, emergency room care, physician visits and surgeries. One hundred and twenty-five thousand deaths annually are attributed to medication non-compliance.

The following chart shows the estimated rates of non-compliance by condition and its consequences:

Non-Compliance and Consequence Table

| | | Patients | |
|---|---|---|---|
| | % Non- | with Disease | |
| Condition | Compliance | (in millions) | Consequence |
| Asthma | 20 | | Hospitalization |
| Arthritis | 55 | 40 | Progression of |
| | | | Disease |
| Contraception | 8 | | Unwanted pregnancy |
| Diabetes | 40 | | Diabetic Compli- |
| | | | cations |
| Hypertension | 40 | 50 | Hospitalization |
| Anti-Coagulation | 40 | | Hospitalization/ |
| | | | Stroke |
| Organ Transplant | 18 | | Deaths |
| Estrogen Deficient | 57 | | Osteoporosis/Hip |
| | | | Fractures |
| Migraine | 36 | | E.R. Visit |

Economic Impact Table

Compliance with anti-coagulants would prevent 40,000 strokes
annually, saving $600 million
Compliance with medication (ACE inhibitors) for congestive heart
failure, saving $2 billion
Estrogen replacement costs $200/year, hip fractures cost $41,000
The U.S. economy loses $50 billion from reduced productivity

Non-compliance is a major barrier to effective healthcare. The medical community has attempted to improve compliance by educating patients about their illness and the rationales for drug therapy. Pill organizer boxes or containers and simplification of the dosage regimen have been tried. These approaches have not been effective in changing patients' compliance behavior.

In addition to increasing health care costs and acting as a barrier to full recovery of the patient, non-compliance can be viewed as a risk factor, both to the patient, the doctor, the doctor's group practice (a number of doctors operating cooperatively as a single unit) and the doctor's or group's professional insurance carrier or company. In other words, patients who do not follow doctor's advice and/or fail to take medications, are also likely to miss appointments, not seek supplemental care at referred healthcare providers, not to exercise or stop other degrading health habits (for example, smoking tobacco). It would be helpful to have a method or system which gathers both medical information and patient compliance data, assesses and monitors the risk to the patient and the doctor and then generates compliance letters, emails, etc. to the patient to motivate the patient to be more compliant to the doctor's orders and advice.

U.S. Pat. No. 5,887,133 to Brown et al. describes a swapping device that (a) identifies unwanted portions or undesirable portions of a downloaded Internet document or information packet and (b) substitutes a desired document into the download package delivered to the user's computer. The controller, controlling the identification of unwanted material in a downloaded Internet document and enabling swapping with another substitute document, may be provided as part of the Internet service provider or, on the user's premises. Brown et al. disclose that the controller may inject medical information as a substitute document into a downloaded Internet document. The patent disclosure states “For example, data bank 216 may contain the medical records indicating that the user is a diabetic and should be reminded to monitor their blood glucose level. In this situation, when original document portion 100 is undesired, swapping mechanism 210 will issue a swapping order addressed to substitute document server 34 to provide a substitute document portion 110 in which information portion 114 contains the message remember to monitor your blood glucose level. In the event the user is trying to quit smoking, substitute document portion 110 may contain the following message: ‘Don't give up! You can quit smoking!’” Column 10, lines 33-43. The patent disclosure also indicates that reminders for monitoring respiratory peak air flow and appropriate medication may be provided to the user as part of the substitute document.

U.S. Pat. No. 5,935,060 to Iliff discloses a medical computer system which provides medical information and diagnosis. Although the computer system identifies a patient medication database and a treatment table database and a patient response database, the detailed description does not reveal that these databases provide interactive prescription drug compliance communications over the Internet with patients.

U.S. Pat. No. 5,857,967 to Frid et al. discloses the utilization of a computer program to generate a web page containing information from a medical device and, upon inquiry from a remote location via the Internet, publish that web page with the data on the Internet.

U.S. Pat. No. 5,924,074 to Evans discloses an electronic medical system. It appears that the Evans patent disclosure generally discusses a comprehensive medical database and method keeping system.

U.S. Pat. No. 5,633,910 to Cohen discloses an outpatient monitoring system utilizing a touch tone or DTMF system. A patient medication compliance database is described. The patient calls the computer and responds, via the dial pad of a telephone, to questions generated by a computer thereby completing a required database table. The Cohen disclosure states “In an alternative embodiment, the outpatient sub-system 12 can include a personal computer coupled to the telecommunications system 13 by a modem, so as to enable modem to modem communication between a patient and the central monitoring sub-system 11.” Column 13, lines 7-11. Further, the disclosure states in connection with FIG. 6, “A patient utilizes the invention by dialing a telephone number supplied by the healthcare provider using a touch tone telephone.” Column 13, lines 39-41. The Cohen disclosure also provides “The present invention can be used to monitor and report side effects of drugs prescribed to a patient. When the healthcare provider determines, based upon the information entered by the patient and stored in the patient's record and database 24, that the patient is being adversely effected by a prescribed drug, the healthcare provider can contact the patient (or have the central monitoring sub-system 11 alert the patient on the patient's next call or call the patient back) and reduce the dose of the medication or change the medication to reduce the side effect. Another use of the present invention is to monitor patient compliance. . . . The system of the present invention can be configured so that a patient reports regularly (for example each day) as to the amount and time that a particular drug was taken. . . . In an advanced embodiment, the central monitoring sub-system 11 can itself call the patient if the patient has not reported within a set period of time and remind the patient (using the voice generator 22) of the need and benefits of taking the prescribed drug.” Column 14, line 43-column 15, line 6.

U.S. Pat. No. 5,596,994 to Bro discloses an automated and interactive computer system design to motivate a patient or client based upon physician instruction. The client database includes client name, calling schedule by week, day and time, a personal identification number PIN for each client and the previous history of messages received and response profiles. The client answers questions by depressing keys on a touch tone telephone (DTMF communication). Communications with the central computer and a pager carried by the patient is also discussed. The Bro patent disclosure further discusses implementing the interactive patient motivational system via a computer network utilizing client and server technology.

U.S. Pat. No. 5,926,526 to Rapaport et al. discloses a medical database.

An Internet web site established by Computerized Monitor/Reminder Service, or PAR Computer Services, Inc., discloses the following: Each and every day, a computerized monitor service telephones a subscriber who is living alone or in questionable health to confirm his or her well being. Once, twice or even three times each day, a computer calls the designated phone number with a customized message for the subscriber. The call is customized (for example, a reminder to take medication). See the web site parweb.com.

Another Internet service, Pharmacy: Personalized Drug Information and Medication Reminder System, discloses a web based application which provides important personalized medication information and reminders to subscribers such as possible side effects, potentially harmful drug interactions, and when/where/how to take medication. See the web site telemedical.com.

### OBJECTS OF THE INVENTION

It is an object of the present invention to provide a computer based method for motivating and monitoring medical compliance by a plurality of subscribers via a plurality of subscriber computers, a central computer and a telecommunications network.

It is another object of the present invention to motivate subscribers to adhere to their respective medical protocol, thereby achieving a higher medical compliance rate, by rewarding subscribers to complete their respective medical compliance plans.

It is a further object of the present invention to motivate subscribers by issuing those subscribers rewards such as coupons, frequent flyer miles, or vouchers for goods or services if the subscribers meet the medical compliance guidelines.

It is a further object of the present invention to monitor and report medical compliance rates for different reward systems, provide reports regarding an individual subscriber's medical compliance, prepare compliance reports for different subgroups of subscribers and provide reports regarding the total effectiveness of the Internet based motivational and reward system.

It is another object of the present invention to provide a risk level monitor based upon a patient's compliance with a patient's medical compliance plan established by a healthcare professional.

It is a further object of the present invention to report the risk level from a range of risk levels or values based compliance of the patient and an effort (communication episodes) to improve the patient's compliance.

It is an additional object of the present invention to provide a risk monitoring system wherein the risk value for a patient is reported to the patient and a total risk value for a plurality of the patients is reported and, coupled with increasing degrees of communication episodes (telephone calls, letters, e-mails), the system attempts to reduce the risk value for a particular patient and reduce the total risk value for a plurality of patients by altering or changing the communication episodes (either the frequency of communication or the type of communication or both).

### SUMMARY OF THE INVENTION

The computer based method for motivating and monitoring medical compliance utilizes a telecommunications network or a plurality of links between a plurality of subscriber computers, each computer associated with one or more subscribers, and a central computer which typically hosts a web site. Local area networks and wide area networks can be utilized rather than implementing the system on the Internet. Each subscriber has a medical protocol to follow as prescribed by a physician or other healthcare provider. Achieving a high rate of medical compliance for the medical protocol is a primary objective of the present invention. This objective is reached by inputting information representing the plurality of medical protocols for the plurality of subscribers into the central computer. In a preferred embodiment, basic medical protocols are initially inputted as a database and either (i) the subscriber inputs key medical data or select data for his or her unique protocol or medical compliance plan into the central computer via his or her computer (a subscriber's computer) or (ii) a third party such as a Managed Care Organization (“MCO”), insurance company or employer download medical data for each subscriber. The central computer also includes a predetermined reward system (implemented as a database) which is based upon medical compliance levels or achievement of predetermined medical compliance plans. Medical protocol, unique to the subscriber, is displayed on the subscriber's computer via the telecommunications network from the central computer. The central computer accepts at least one input from each subscriber indicative of the subscriber's compliance with his or her medical protocol or medical compliance plan. The central computer issues a reward to the subscriber based upon the compliance input and the predetermined reward system.

The risk monitor is implemented as a computer based method, a program or a computer system which monitors medical compliance by a plurality of patients having a corresponding plurality of medical compliance plans. The plans for each patient are displayed and the system accepts input from the patient indicative of the patient's compliance with the plan. The system then assesses or analyzes the input and assigns a corresponding risk value based upon a range of risk values for various degrees of compliance. In addition, the patient's lifestyle inputs can be added to determine the risk value. The assessment continues for a plurality of patients thereby providing an indication of the risk value (a total risk value) for a doctor, group of healthcare providers, a clinic or a hospital. By implementing various communication episodes (telephone calls, e-mails, letters), the system seeks to reduce the risk value for a particular patient and for the plurality of patients by altering the communication episodes and monitoring the resulting risk values both individually and as a group.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates the telecommunications network and particularly illustrates a web based implementation of the medical compliance system and method;

FIG. 2 diagrammatically illustrates a system wide data flowchart for the medical compliance method implemented over the Internet or a wide area network;

FIG. 3 diagrammatically illustrates a top level system diagram or flow chart showing the major processes of the medical compliance system;

FIG. 4 diagrammatically illustrates the subscriber record process and flowchart;

FIG. 5 diagrammatically illustrates the medical database record process or flowchart;

FIG. 6 diagrammatically illustrates the compliance process or flowchart;

FIG. 7 diagrammatically illustrates the reward process;

FIG. 8 diagrammatically illustrates one implementation of a communications module or process;

FIG. 9 diagrammatically illustrates a compliance report process;

FIG. 10 diagrammatically illustrates a marketing process subroutine or module;

FIG. 11 diagrammatically illustrates an administrative process;

FIG. 12 diagrammatically illustrates a regulatory filter which is utilized to conform the system to current healthcare regulations;

FIG. 13 diagrammatically illustrates a general system chart for the risk assessment or monitoring system;

FIG. 14 diagrammatically illustrates data flows; and

FIG. 15 diagrammatically illustrates the process or flow chart for the risk monitor.

### DETAILED DESCRIPTION OF THE PREFERRED EMBODIMENTS

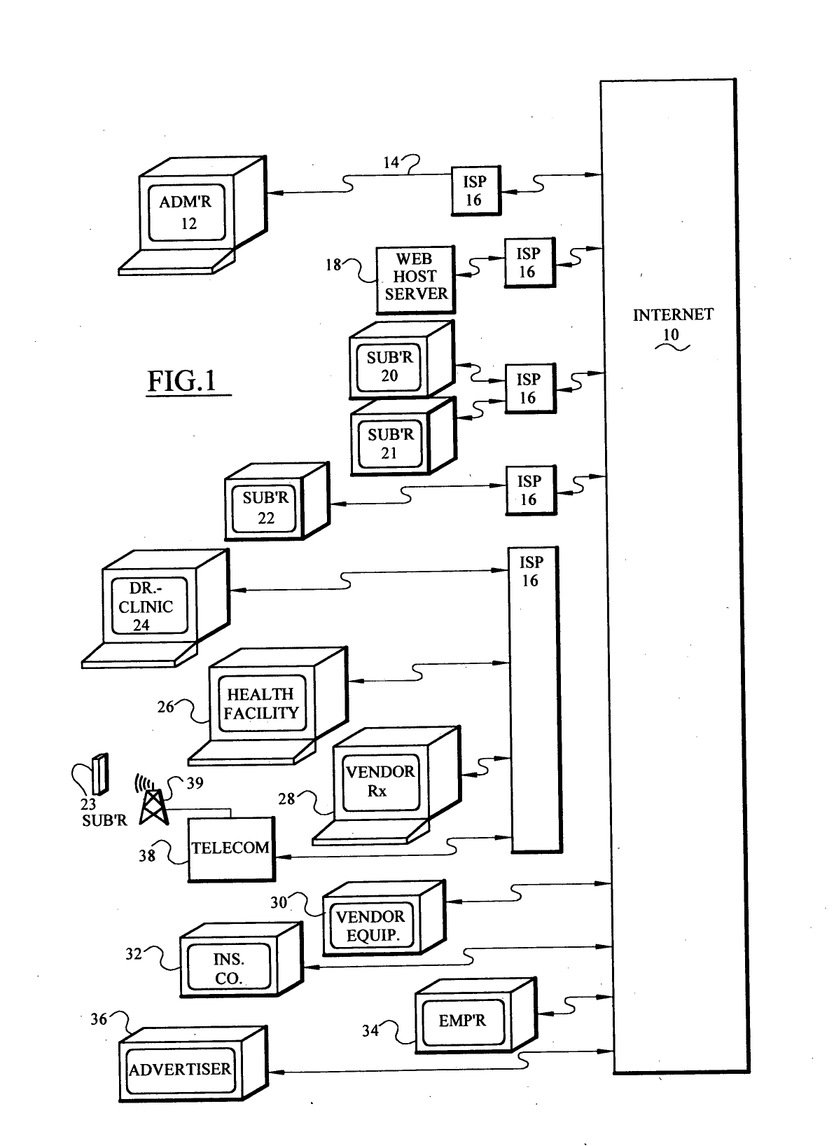

The present invention relates to a computer based method for motivating and monitoring medical compliance by a plurality of subscribers and assessing and monitoring risk for the patient, the doctor, the doctor's group and the professional insurance carrier. By adjusting the motivation and compliance reminders, patient compliance increases and personal and professional and community risks are reduced. FIG. 1 diagrammatically illustrates a widely distributed telecommunications network or a web based implementation of the present system (i.e., the Internet). Persons of ordinary skill in the telecommunications and computer network fields will appreciate that Internet 10 may be replaced by a local area computer network or a wide area computer network. The administrator of the system utilizes computer 12 which is connected, via telecommunications line 14, to an Internet Service Provider or ISP 16. ISP 16 may be AT&T, MCI-Worldcom, Sprint or other type of telecommunications carrier connected into and integrated with Internet 10. Although a plurality of ISPs 16 are illustrated in FIG. 1, persons of ordinary skill in the telecommunications and computer fields will appreciate the interchangeability of these various service providers to users, customers and subscribers. In an Internet implemented version of the present invention, the administrator on computer 12 establishes a web site on web host server 18. Alternatively, the combination of administrative computer 12 and web host server 18 is considered “a central computer.” Processing may be centralized in computer 18 or shared between computers 12 and 18. It is well known that administrative computer 12 can be configured such that it is a web host server for the Internet. When the computer is configured as a web server, a large plurality of subscribers, companies and other individuals can access the web based application on host or central computer 18 (with or without assistance from computer 12) via Internet 10. Internet 10 represents a plurality of telecommunications links or telecommunications channels. Accordingly, subscriber computers 20, 21 and 22 access the administrator's web based application on host computer 18 substantially simultaneously.

Healthcare providers such as doctor or clinic computer 24, health facility computer 26 and pharmaceutical or drug vendor computer 28 also access Internet 10 via ISP 16. Equipment vendor computer 30 is provided access to Internet 10 and to web host server computer 18. Although web host computer 18 is primarily discussed herein, it should be noted that the concept of “web host computer or server 18” includes the concept that computer 18 is configured as a central computer with or without administrator computer 12.

In a preferred embodiment, the medical compliance system is financially supported by compliance system sponsors. The system sponsors include, in a preferred embodiment, an insurance company utilizing computer 32 and/or one or more employers of subscribers 20, 21, 22. One of the employers utilizes employer computer 34. Advertisers are linked to Internet 10 via advertiser computer 36. Ads from computer 36 are posted on host central computer 18 under the control and administration of computer 12.

With the advent of cellular telephones capable of displaying web based information pages and launching web browsers, the computer based medical compliance system can reach subscriber cell phone 23 via telecommunications link 38 and broadcast antenna system 39. Subscriber cell phone 23 also represents small hand held computers some of which are sold under the trademark PALM PILOT. The medical compliance system described herein operates equally well on subscriber PALM PILOT and other small, hand held computers.

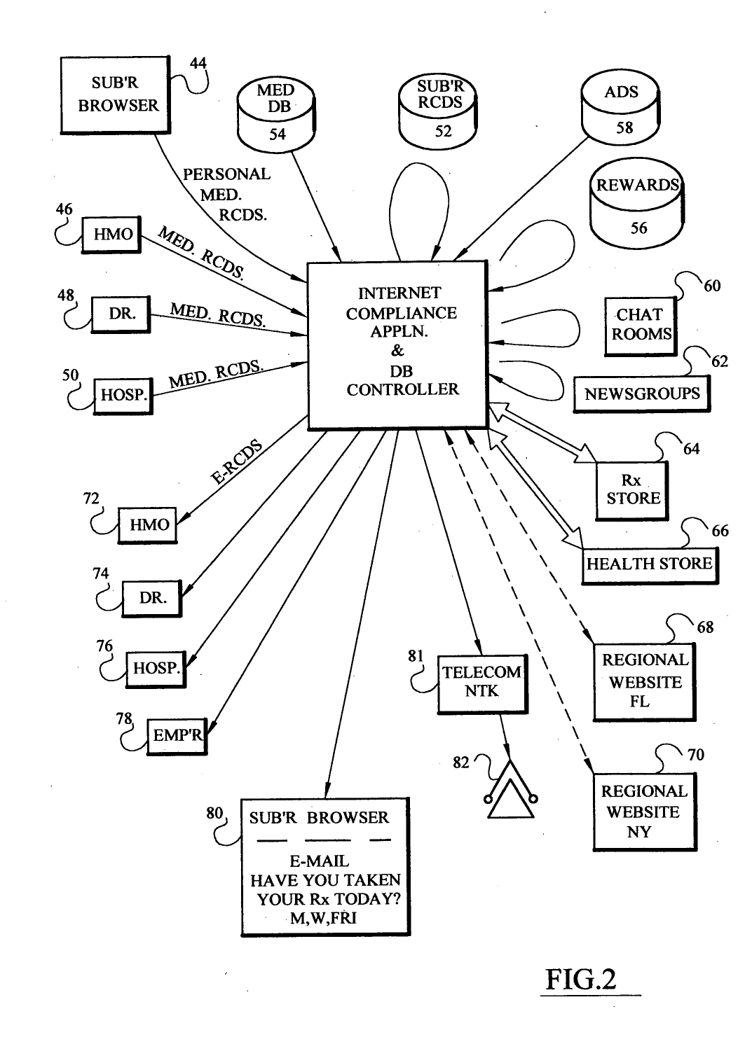

FIG. 2 diagrammatically illustrates basic data flow for an Internet based medical compliance system in accordance with the principles of the present invention. As described in detail hereinafter, the present system is a web based application and a database controller which is represented by Internet compliance application data element 42.

Certain abbreviations are utilized herein to describe certain entities, data or informational constructs, systems or reports. The following Abbreviations Table lists some of the abbreviations utilized herein.

### Abbreviations Table

Acct account
Admin administrative
Adm'r administrator or systems operator
Adver's advertiser
appt. appointment or appointments
comp compliance with medical protocol or plan
DB database (or similar configured spread sheet)
Dr. physician or clinic
Emp'r employer
e-reminder e-mail communication
equip equipment
HMO health maintenance organization
Hosp hospital
Internet global computer communications network
Ins or Ins. Co. insurance company
ISP Internet service provider
M,W,F days of the week (Monday, Wednesday, Friday)
Med medical
mgt management
Ntk network
Pat. patient
Pat-sub'r patent-subscriber
PDR Physician's Desk Reference or other similar drug encyclopedia
PMS practice management system
rcds records
rpts reports
rvw review
serv'r server
stmt statement or policy
sub'r subscriber
supple supplement
sys system
telecom telecommunication

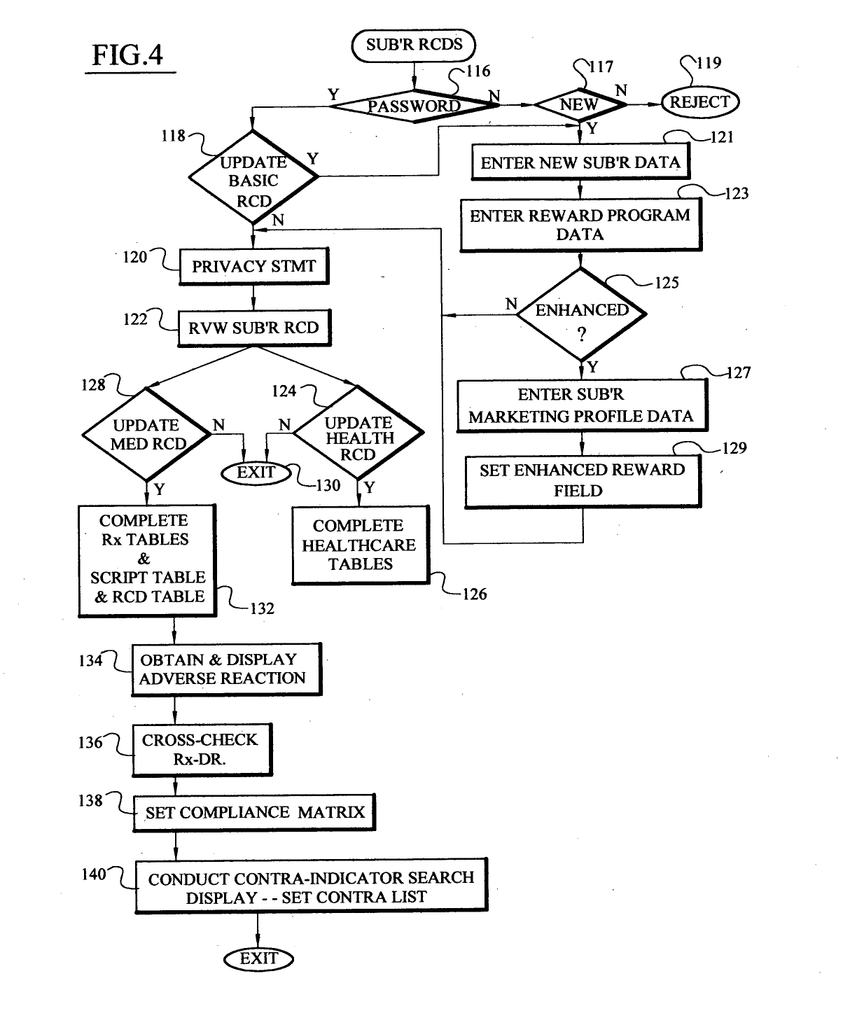

The basic data flow diagram in FIG. 2 shows that subscriber browser 44 enables the input of personal medical records, including individual medical protocol, subscriber data, and key medical data utilized in connection with the individual's medical compliance plan. This data is input into web based compliance application 42. Further specifics regarding data input by the subscriber via subscriber browser 44 is discussed in detail later in connection with FIG. 4, among others.

In an enhanced version of the present invention, patient or subscriber medical records are input into Internet compliance application 42 from healthcare providers such as HMO 46, doctor or clinic office 48 or hospital 50. Although the medical record data is obtained from a different source, the processing of the data system is substantially similar.

This information is stored, updated, modified and retrieved from subscriber record database 52. Further, the Internet compliance application 42 utilizes stored medical protocol or basic or predetermined medical compliance plans in medical database 54. This basic information typically is uploaded to host computer 18 (FIG. 1) during an initialization phase for the present system. As an example, basic medical protocol and basic medical compliance for a person on medication to reduce high blood pressure may input the drug name and the system may suggest compliance at 2 times per day. The subscriber may change the compliance to 3 times per day based upon his health provider's instruction. The basic medical protocol is stored in medical database 54. The specific medical protocol for the subscriber (two daily doses as compared with three daily doses) is stored in subscriber record database 52.

A key feature of the present invention is that the subscriber visits compliance application 42 on a periodic basis and updates the subscriber's individual medical compliance plan. As used herein the term “plan” refers to a projected regimen of medication use, physical therapy or physical exercise to achieve either a healthier physical presence or to cure an ailment or to treat a medical condition. The term “medical protocol” is used to refer to a widely recognized treatment regimen for a disease or physical ailment.

In order to motivate and incentivize the subscriber, the subscriber, when he or she achieves certain levels of medical compliance, is rewarded based upon a pre-established reward schedule or system. The reward schedule is located in reward database 56. To further economically support the medical compliance system, advertisements from ad database 58 are displayed to subscribers while they browse Internet compliance application 42. Chat room 60 and news group 62 are provided as a community service and to keep the subscribers at the compliance application web site. Further economic support for the Internet application 42 is provided by hyperlinks or electronic referral services to drug or Rx stores 64 and health stores 66. Educational chat rooms and personal dairy storage areas are also provided by the present system.

In the event Internet application 42 becomes unwieldy or slow, portions of the system or subscribers accessing the system may be transferred to regional web sites. Regional web sites designating the geographic territory of Florida 68 and New York 70 are illustrated in FIG. 2. Regional web sites 68, 70 may be utilized to provide local healthcare information to subscribers regarding hospitals, local drug stores, local healthcare equipment stores, etc.

An added benefit of the compliance reward system is the generation of medical compliance reports. For example, electronic medical compliance records, either specifically unique to the patient-subscriber or unique to a subgroup of subscribers having similar conditions (for example, AIDS) or a larger group of subscribers identified based upon a higher or a lower reward system may be generated and delivered to MD report computer 72. In a like manner, HMO report computer 74, hospital report computer 76 and employer report computer 78 may receive electronic reports records from Internet compliance application 42.

As stated earlier, one key element of the present system is the subscriber browsing and arriving at compliance application 42. At the web site 42, the subscriber browser 80 displays a question: “Have you taken your Rx today?” Similar questions regarding physical well being may be substituted for the drug consumption inquiry. This web browser display 80 may be unique to a day, a day of a week or a time of day, or a combination thereof. Further, the subscriber may be sent an electronic reminder or e-mail to remind the subscriber to take his or her medication or renew his or her prescription.

The term “subscriber” is utilized herein rather than the term “patient” because the person utilizing the medical compliance application 42 is not considered a “patient” of the medical compliance application 42. Web-based system 42 is not a healthcare provider and hence does not have “patients.” However, subscribers are typically patients of providers. The subscriber is a patient of a doctor, healthcare provider or employer. Viewed from a different prospective, the subscriber is a user of the medical compliance computer based application since he or she subscribes or participates in the information exchange between compliance application 42 and the user's or subscriber's computer.

As a further enhancement to the present system, compliance application 42 may be linked to a telecommunications network 81 and a telephone 82 which is associated with the subscriber. If the subscriber does not take his or her medication for several days, i.e., does not respond to e-mail or logon for example, medical compliance application 42 initiates a voice communications session with the subscriber via telephone 82.

The present medical compliance application seeks to (a) satisfy a medical objective, that is, to increase medical compliance; (b) inform and motivate subscribers to achieve higher rates of medical compliance; (c) introduce and provide financial support to a medical compliance program with compliance system sponsors. The following Compliance System Sponsor Table provides a short list of typical entities that would benefit by higher rates of medical compliance.

Compliance System Sponsor Table

Insurance Companies
HMOs
Employers
Health Care Providers
Pharmaceutical Companies

The present system has certain important objectives that are set forth below in the Basic Focus Table.

Basic Focus Table

Importance of taking medication as prescribed
Renewing the prescription (Rx)
Emphasize personal wellness benefits and consequences of poor
compliance

Compliance system sponsors are integrated into the medical compliance application as set forth in the following Motivational Reward Table.

Motivational Reward Table

through the patient's employer

extra vacation time
additional company benefits
opportunity to participate in drawings for prizes

through HMO, insurance carrier etc.

lower premium
additional benefits
prizes

through a pharmacy

discount coupons
free or reduced price products
discounts at retail store or on line store

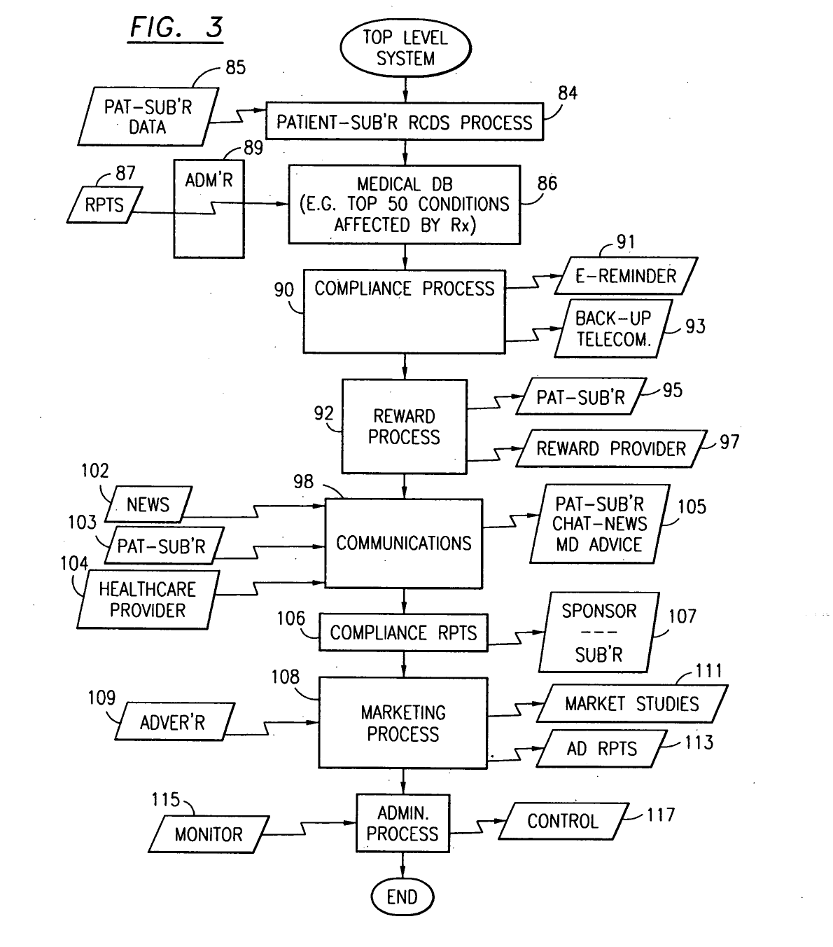

FIG. 3 diagrammatically provides a top level system diagram showing the major processes, functions or routines utilized in connection with the present invention. It should be noted that these processes or routines may be reorganized to achieve better efficiencies. The sequence or flow and execution of functional block elements described herein provides only one example of many of an implementation of the present invention. Persons of ordinary skill in the computer arts field will recognize opportunities to improve the efficiency of the present system.

Patient or subscriber records are initialized, input, updated, modified and deleted by the subscriber records process 84. Input is obtained from the patient-subscriber has shown by subscriber data input block 85. Medical database process 86 is utilized to keep medical database 54 (FIG. 2) current and robust. Medical reports 87 are input into the database and the administrator, in function block 89, filters, abstracts or otherwise indexes those reports into medical database 86. In an initial implementation of the present invention, the top fifty (50) conditions affected by pharmaceutical products will be addressed as part of the medical compliance application 42.

Compliance process 90 processes the data from the subscriber records and the medical database and delivers, in an enhanced version of the present invention, e-mail reminders as outputs 91 and backup voice telecommunications outputs 93.

Reward process 92 generates and issues rewards to patient-subscriber output 95 and also generates reward reports to companies that provide rewards, i.e., reward providers, as output 97. Communications process 98 accepts news input 102, patient subscriber input 103 and healthcare provider input 104. Communications process 98 outputs subscriber chat room, subscriber news groups and medical education as output 105. Compliance reports function 106 generates outputs to the sponsors and subscribers as output 107. Marketing process 108 accepts information and ad content from advertiser input 109. Process 108 outputs market studies 111 and advertising reports as output function 113. Administrative process 114 has an input function which monitors the system as monitor 115 and output control 117.

FIG. 4 diagrammatically illustrates the subscriber record process 84 initially shown in the top level system diagram of FIG. 3. Each major process function is outlined as a separate flowchart. See the Brief Description of the Drawings. After initialization of the system, the subscriber record process in decision step 116 determines whether the password entered by the subscriber is valid. It should be appreciated that the present invention contains and catalogs confidential medical information generally unique to each subscriber. Password control can be distributed throughout the system at multiple security levels. If the password is not valid, the NO branch is taken to new subscriber decision step 117. Step 117 determines whether the subscriber is new to the system, if not, the NO branch is taken and the system rejects the electronic inquiry in step 119. If YES, the system executes step 121 and enters new subscriber data. The following Patient-Subscriber Data Table provides some basic information that is typically found in the subscriber records. Other data fields may be added as necessary.

Patient - Subscriber Data Table

name
address
phone number (day, night, work)
spouse
e-mail address
referring entity information

name
city, state, zip code

marketing profile data
Enhanced Reward Field YES/NO
employer data
reward program data

airline frequent flyer (ff)

pop-up list of airlines
ff number

credit card reward points

pop-up list of cards
input reward number

hotel (similar sub-system)

emergency contact person

name
phone number

Subscriber Compliance Record
Subscriber Reward Account Record
Subscriber News Release Record

Step 123 permits the new subscriber to enter reward program data into his or her subscriber data table. This reward program data includes airline frequent flyer data, credit card reward system data, hotel reward system data or other types of reward point system data. Decision step 125 determines whether the subscriber wants an “enhanced” subscriber record. If not, the NO branch is taken and the system jumps to a point immediately before the display privacy statement step 120. If the subscriber wants an “enhanced record,” which translates into a higher level of reward or bonus point multiplier, the YES branch is taken and the system executes step 127 which prompts the subscriber to enter additional information regarding his or her consumer profile. The Marketing Profile Data Table set forth below provides some basic examples of this enhanced compilation of subscriber data.

Marketing Profile Data Table

zip code
family status (married, children, divorced, single)
age
age of children
car data (cost, lease/own, how old)
hobbies (select from pop-up list (searchable))
family income (select from range)
occupation (select from alphabetic list)
spouse data
pets
vacation destination, frequency
magazine subscriptions
data regarding typical pharmacy, grocery store etc.

In step 129, the system sets the “enhanced reward data field” to YES. If the NO branch was taken from decision step 125, the enhanced reward data field is set NO. The primary purpose for permitting the subscriber to enhance his or her subscriber database and increase the amount of reward for achieving a high level of medical compliance is directly related to the advertising financial support for the system. If an advertiser has more information regarding the subscriber who is currently viewing the web based application, the advertiser can target that subscriber with certain types of ads. These ads have a higher motivational factor and hence a higher impact on the subscriber-viewer and a higher probability that the subscriber-viewer will purchase the advertised goods or services.

Returning to password confirmation step 116, if the password is valid, the YES branch is taken and the system executes decision step 118 which determines whether the subscriber wants to update his or her basic record. If YES, the program branches to a point immediately before step 121 which is enter new subscriber data. This enables the subscriber to update or modify his or her data in the Subscriber Data Table set forth above.

If the NO branch is taken from decision step 118, the system in step 120 displays a privacy statement. The privacy statement, although not operationally necessary, is desirable since the system is handling confidential medical information for each subscriber. Step 122 permits the subscriber to review the subscriber record. At that point, the subscriber can select update medical record step 128 or update health record step 124. If the NO branch is taken from either one of these decision steps (which may be pop up buttons or pull down menus on the web based browser), the system exits in step 130 and the subscriber, browsing the site, is shuttled to an exit path (which may include ads, news updates, etc.). If the subscriber selects update health record 124, the YES branch is taken and step 126 permits the subscriber to complete the healthcare tables set forth below. Examples of several Healthcare Tables are set forth below. The General Healthcare Provider Table relates to basic information that the system stores and records in subscriber record database 52 (FIG. 2).

General Healthcare Provider Table

Primary doctor

city, state, zip code
phone number

Under Current treatment YES/NO
Rx number
ailment (pop-up, alphabetic list)/or basis for taken medication

(ex-oral contraceptives)

closest hospital

city, state
phone number

In addition to general information regarding the subscriber's primary healthcare provider and healthcare system, the subscriber may be involved with a healthcare specialist. The following Specialist Healthcare Provider Table is an example of a basic information data table.

Specialist Healthcare Provider Table

specialty
name, address, phone number
Rx number
ailment

If the subscriber selects update medical record step 128, the YES branch is taken and in step 132 the subscriber completes the Drug or Rx Tables and the Script Table. Examples of these tables are set forth below.

Rx Drug Table

generic drug name
trademark drug name (cross check, search and confirm)
dosage each unit
Rx number
frequency of use (day, time)
how many (pop-up menu 1, 2 tablets, 1 tsp. etc.)
how long
prescription renewal date

Program Response: contra - indicator list

For additional medications, the subscriber completes the following supplemental table.

Supplemental Rx Table

Rx 1

Renewal Date

Rx 2

Renewal Date

Rx 3

Renewal Date

To document the healthcare provider issuing the medication, the following table is utilized.

Script Writer Table

Rx number
doctor name

city, state, zip code

speciality

Renewal Date - follow up visit date

The Rx Drug Table provides some basic information which is either necessary or helpful for the operation of the medical compliance system. For example, the subscriber may be required to input the trademark drug name and the system may conduct a database search through medical database 54 and display the generic drug name. The user may be prompted to confirm that the generic name correctly identifies the trademark drug name. A further confirmation correlates the displayed names with the Rx name on the pill bottle. Rx number is simply a tracking number. The Rx number may be the number assigned to the prescription as issued by the pharmacy. Reference herein to “pop up menus” or tables refers to items on web based systems which display informational choice selections to reduce the data input time by a subscriber. The Rx Drug Table above also includes the concept that the medical compliance system may conduct a contra-indicator search in order to determine whether the drug currently inputted by the subscriber is not contra-indicated with any other drug currently logged into the system by the subscriber in subscriber record database 52.

The Supplemental Rx Table is simply one or more multiple tables for drugs Rx 1, 2 and 3. The Script Writer Table provides an input screen or data format to track who prescribed the drug to the subscriber (i.e., physician) and who filled the drug (i.e., pharmacy) and the renewal date.

Step 134 obtains adverse or contra-indication information and adverse reaction information from medical database 54. This information is obtained based upon the data input by the subscriber in step 132 and a search through the medical data base 54. In step 136, the system cross checks the prescription with the doctor. In other words, certain doctors would not commonly prescribe certain medications. The medical compliance system described herein includes the concept that various cross-checks occur between drug data input by the subscriber and the relationship of those drugs to the identified healthcare providers. For example, urologists prescribe VIAGRA and gynecologists typically do not.

Step 138 conducts a contra-indicator search in order to determine whether drug Rx 1, 2 or 3 are contra-indicated with each other. Step 138 also displays any contra-indication information to the subscriber. Step 140 establishes or completes the Compliance Matrix. The following Subscriber Compliance Record Table preferably utilizes a template which is based upon basic medical protocol obtained for similar drugs in medical database 54. For the example identified above with respect to the high blood pressure medicine, the matrix maps out and displays to the subscriber days 1-8 and permits the subscriber to select 1, 2, 3 or 4 time entries per day. In this manner, the subscriber completes a matrix or table of data for each prescription Rx 1, Rx 2, Rx 3. This represents key medical protocol data. In a similar manner, the subscriber may be required to complete a physical therapy basic input routine or a physical exercise basic input routine. As an example, a person who undergoes surgery on his or her knee cartilage must do, for example, 20 leg lifts in the AM and a second set of 20 leg lifts in the PM. This physical therapy or exercise can be part of the described medical compliance system.

Subscriber Compliance Record Table

current day time
Rx 1 matrix, e.g., Monday AM-PM, Tuesday AM-PM, etc.
Rx 2 matrix
Rx 3 matrix
Activity 1 matrix
Activity 2 matrix
Non-compliance count

Typically, the data for the Subscriber Compliance Record Table is input in step 132. In step 140 after the contra-indication and cross-check searches, the system generates an individual Compliance Matrix which is essentially, in one embodiment, a calendar display. The calendar may be printed by the subscriber. For the example discussed above, if the current date refers to Monday, the day of the week, date and Rx number appears on the calendar map with times 8AM and 8PM. The “12 noon” entry is set forth in the Compliance Matrix Table to illustrate periodic or multiple time entries. The following “reminder Y/N” is an electronic reminder field. It is hidden from the subscriber's view. When the compliance system delivers an electronic reminder (discussed below), the field changes from NO to YES. In the far right column, the confirmation field is completed by the subscriber. The Y/N in this field is blank until filled by a subscriber. The subscriber changes the character of the field from NO to YES (or blank to N/Y). In this manner, the subscriber inputs data relative to his or her completion of a medical compliance act to meet the pre-set medical protocol or plan. The medical plan is established by the Subscriber Compliance Record Table. The empty or partially completed medical compliance table is a plan of action which must be executed by the subscriber. As the subscriber achieves their goal (an act of compliance), by taking drugs, completing a physical exercise or a physical therapy, the subscriber enters data indicating that he or she has completed that goal by changing the state of the confirmation field. The Individual Compliance Matrix set forth below repeats the calendar for drugs Rx 2 and for the next day Tuesday, and drugs Rx 1 and Rx 2 as necessary. The system displays drug name rather than an Rx number.

Compliance Matrix (Individual)

| | | |
|---|---|---|
| Monday | 09-28-1999 | Rx 1 |
| 8 AM | reminder Y/N | confirm Y/N |
| 12 noon | reminder Y/N | confirm Y/N |
| 8 PM | reminder Y/N | confirm Y/N |
| Monday | date | Rx 2 |
| daily time | e-reminder | confirm Y/N |
| Tuesday | date | Rx 1 |
| daily time | e-reminder | confirm Y/N |

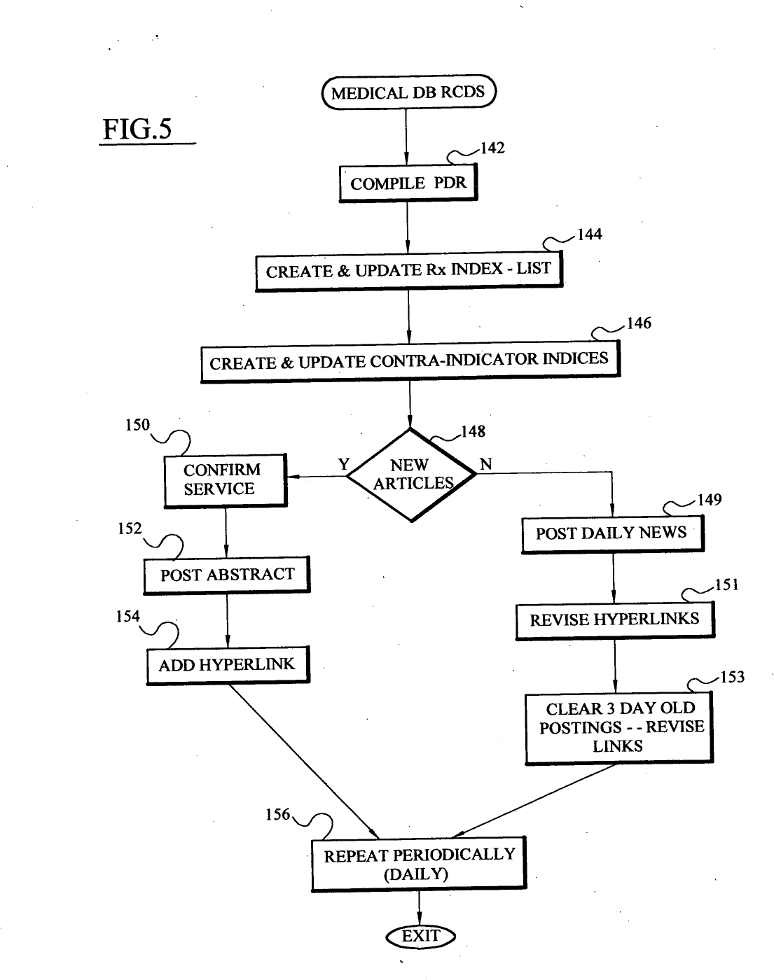

FIG. 5 shows the major components of a medical database record process. Step 142 compiles an electronic version of a PDR or drug encyclopedia in order to establish a contra-indication table and other beneficial features of the medical compliance system. Step 144 creates and updates the drug index list. Step 146 creates and updates the contra-indicator indices. The creation of lists and indices is important in order to enhance the speed of search requests and search outputs from medical database 54. Decision step 148 determines whether the system operator has been sent a new medical article. If not, the system executes the NO branch and the operator posts daily medical news in step 149 and revises hyperlinks or electronic jump points from the medical compliance system to other web-based systems. The revised hyperlink step 151 embodies this concept. Step 156 clears old news postings and revises the hyperlinks.

If the YES branch is taken from new article step 148, the system operator in step 150 confirms the source of the articles. Since the Internet contains a large amount of information, confirmation of source is recommended. Step 152 creates an abstract of the article (or index search terms) and enables the system operator to post the abstract for the new medical article on the web site. Step 154 adds a hyperlink from the medical compliance system to other sources. Step 156 repeats the medical update record process periodically, such as daily.

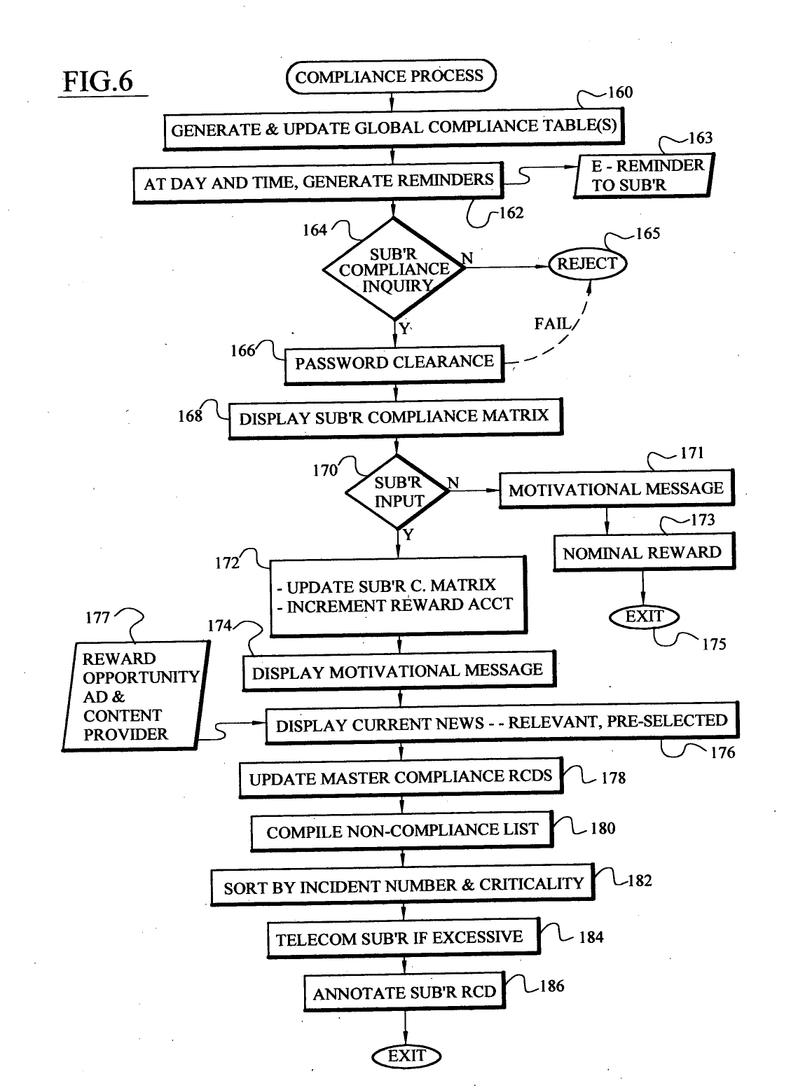

FIG. 6 diagrammatically illustrates a compliance process or flowchart. The compliance process begins by generating and updating a global compliance table in step 160. The following Compliance Generator Table provides some primary features of this generate and update global compliance table step 160.

Compliance Generator Table

1. compile current day, current time block (e.g., 1 hour window) for
each compliance table
2. compile subscriber e-mail message with address, Rx, activity and
message
3. launch e-mail reminders

For example, the system searches for times in the Individual Compliance Matrices which fall within a current time block (i.e., 11:12-12:12 EST). The time block may be for example, a one hour window about 8AM. The next major function involves compiling subscriber e-mail messages or reminders with the subscriber e-mail addresses, drug indicator labels, activity and automatically formatting the message. The third major feature involves launching the e-mail reminders. “Push” technology may also be used. Step 162 in FIG. 6 recognizes that a certain time and day, reminders are generated by the system. Output function 163 shows that e-mail reminders are sent to subscribers. Cookies placed on subscriber computers may prompt subscribers to take medication, visit the site and complete a compliance data input routine.

Decision step 164 determines whether the subscriber has made a compliance inquiry, if not, the system executes rejection step 165. If YES, the system determines in step 166 whether the subscriber has a valid password. If not, the system inquiry fails and executes rejection step 165. If the password is valid, the system, in step 168, displays the subscriber Compliance Matrix. The subscriber Compliance Matrix is an empty, a partially completed or fully completed Compliance Matrix discussed above. A completed matrix shows that at each time and date entry, the subscriber has confirmed (YES) that he or she has taken the drug. Completion of physical therapy is also input here.

In step 170, a decision is made regarding whether the subscriber has inputted or changed any confirmation fields in his or her Individual Compliance Matrix. If not, the system displays a motivational message in step 171, issues a nominal reward in step 173 to the subscriber and exits in step 175. A nominal reward is provided to the subscriber even though the subscriber has not confirmed that he or she has taken the medication. This nominal reward is available simply to motivate the subscriber to visit the medical compliance web site. If the subscriber has confirmed a compliance level, the YES branch is taken from decision step 170 and the system executes step 172 which updates the subscriber's compliance matrix. Further, the subscriber's reward account is incremented. In order to keep track of rewards points issued to subscribers, each subscriber has a reward account. This reward account is associated with the subscriber data table. The reward account is similar to a bank account. Points have a pre-assigned or predetermined value, the prizes or rewards have pre-established values and these reward elements are stored in a reward system database 56. Points are used to buy or redeem prizes or rewards. Subscribers may also lose points if they do not comply.

The system in step 174 displays a motivational message to the subscriber. The system in step 176 displays current news to the subscriber which is relevant and preferably falls within a category which is pre-selected by the subscriber. The subscriber pre-selects his or her favorite news based upon the initial subscriber data table, the particular pharmaceutical drugs which the subscriber is taking, the particular ailment (for example, AIDS) which is affecting the subscriber or based upon the data in the Marketing Profile Data Table above. Input step 177 indicates that a reward opportunity is available to advertisers and other content providers. It is moderately well established that individuals who have a high rate of medical compliance are motivated to accept certain additional compensation or information. Input 177 recognizes this type of individual and permits advertisers to financial support the medical compliance system.

In step 178, the system updates the master compliance records. These master compliance records include records regarding compliance for different types of drugs, different types of ailments or different types of physical therapy. The system in step 180 compiles a non-compliance list. If a subscriber does not confirm the adherence to a medical compliance plan, the system monitors non-compliance and issues an additional reminders, initiates voice communications or other type of electronic or telecommunications routines to contact the subscriber to reduce reward level. In step 182, the system sorts non-compliance by critical incident, number and subscriber criticality (quantity, quality and age of subscriber). In step 184, the system telephones the subscriber if non-compliance is excessive (failure to repeatedly take insulin) or potentially fatal (failure to take heart medication). In step 186, the system annotates the subscriber record. Annotation of the subscriber record, particularly regarding telephone contact, may be important.

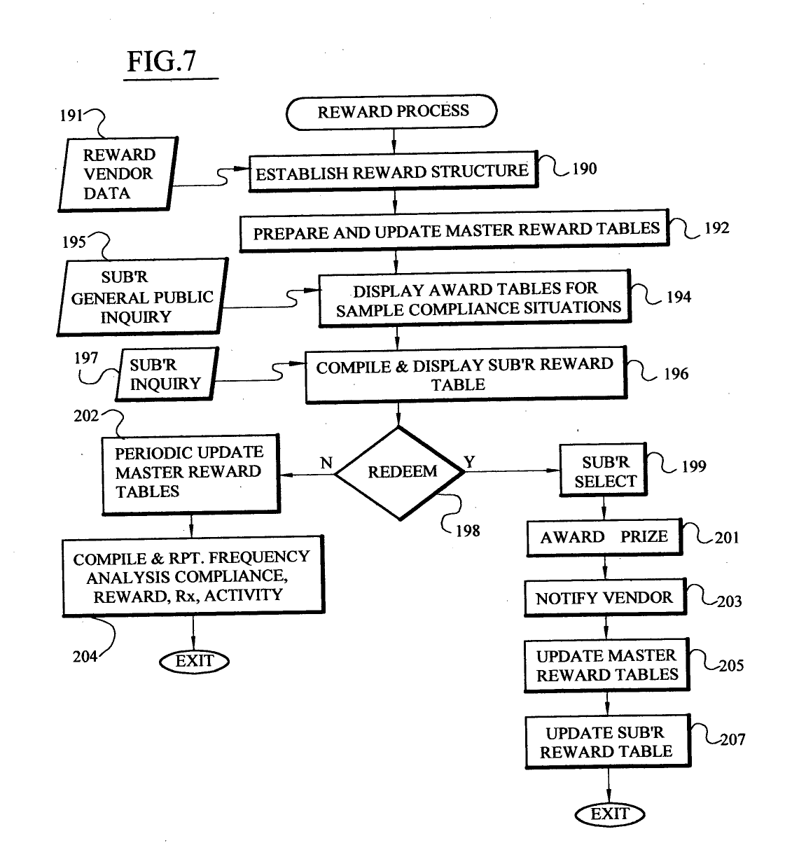

FIG. 7 diagrammatically shows a reward process. In step 190, the system establishes a reward structure. An example of a reward structure is generally set forth in the Reward Table set forth below.

Reward Table

Vendor 1

Prize 1 -- award level -- mm points -- description

-- open date -- close date -- redemption count

Prize 2 -- data fields continued
Prize n -- data continued

Vendor 2 -- data continued
Vendor q -- data continued
Subscriber

pre-selected target reward
pre-selected vendor
target award level
current reward points
subscriber compliance record table
historic rewards

The Reward Table identifies a vendor or a supplier of a reward, establishes a point level or medical compliance level to obtain the reward (for example, a certain number of points), describes the reward, and provides an opening day or an initial availability day and a close day or the last day the reward is available. In some instances, the vendor may limit the amount of rewards available to the system. Accordingly, a subscriber redemption count for each vendor and prize is compiled by the system. The Reward Table shows that vendor I has several prizes and the system has numerous vendors 1, 2 . . . 8. The Reward Table also shows that the subscriber has identified certain reward characteristics which he or she desires. The subscriber pre-selects a reward target and/or a certain reward vendor. Further, the subscriber is motivated by being shown his or her target point value and his or her current reward points in the account. Additionally, the Reward Table set forth above enables the subscriber to look at his or her historic compliance record. The subscriber records may be stored in subscriber record database 52 or other type of database (i.e., the reward database). A programmer of ordinary skill in the art can determine whether these records are better placed in subscriber record database 52 or reward database 56.

The establishment step 190 obtains an input from reward vendor data input function 191. Step 192 prepares and updates the master reward tables for all the vendors and all the subscribers. Step 194 displays reward or award tables for sample compliance situations. It is fairly well established that in order to motivate subscribers, it is important to show subscribers, before they enter data into the system, what reward they would obtain by participating in the computerized medical compliance system. Input step 195 recognizes that the subscriber or members of the general public may make an inquiry into the medical compliance system in order to view the reward tables.

Step 196 compiles and displays an individual subscriber's reward. This individual subscriber's reward is set forth above in the Reward Table. Input step 197 recognizes that a subscriber has initiated an inquiry into the system.

Decision step 198 determines whether the subscriber has requested a redemption of points and selection of a prize or reward. If YES, the subscriber in step 199 selects the appropriate reward and in step 201 the system awards or issues the prize to the subscriber. For example, the reward may be a coupon for a discount for goods or services. The system generates an electronic signal which, when received by the subscriber's browser, causes the subscriber's printer to print a coupon. This feature and other electronic reward system is encompassed by step 201. An electronic coupon for CDs is an example. Step 203 notifies the vendor of the reward that a redemption has occurred. Step 205 updates general or master reward tables in order to provide accurate records regarding motivation, medical compliance and reward issuance. Step 207 updates a subscriber reward table. This update includes a reduction in the amount of points in the subscriber's reward account and an indication that an award has been issued to the subscriber.

If the NO branch is taken from redemption step 198, the system executes step 202 which periodically updates the master reward table. In step 204, the system compiles and reports frequency analysis relating to medical compliance, number of visitors on the site, reward/benefit analysis, drug use and physical therapy use.

In the reward process and particularly regarding display award table step 194, the following Exemplary Reward Table is instructive.

Exemplary Reward Table

| Heart Rx | day 1 | day 2 | day 3 | day 4 | day 30 |
|---|---|---|---|---|---|
| Rewards Points | 1,000 | 1,000 | 1,000 | 1,000 | . . . total 30,000 |

First visit bonus points 1,000
Points for visiting medical site but you didn't take your Rx 200 pts.
First reward level 30,000 points for basic prize

Reward fee for health club: 50% coupon for 1 month

$25.00 credit coupon for golf clubs

| Compliance Failure | day 1 | day 2 | day 3 | day 4 | day 30 |
|---|---|---|---|---|---|
| Lost Points | 100 | 200 | 300 | 400 | . . . total 2,000 |

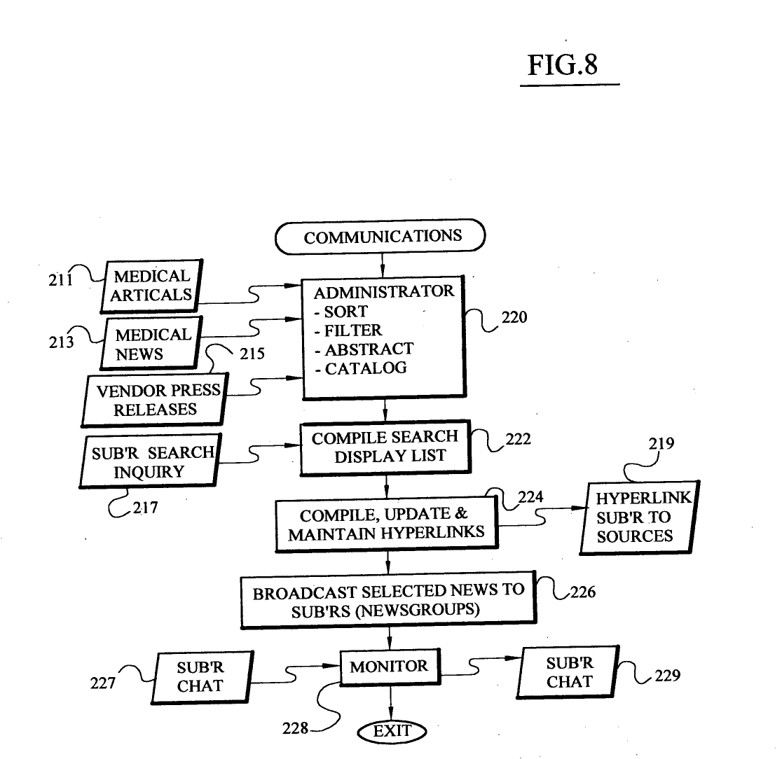

FIG. 8 diagrammatically shows the major components of a communications process. The administrator in step 220 sorts, filters, abstracts and catalogs various medical information delivered to it or obtained by the system from outside sources. These outside sources include medical news input 211, medical articles input 213 and vendor press release input 215. Some of this information may be discarded by the administrator and some of this information may be abstracted and posted on site and hyperlinks between the medical compliance system and the source of the article or the news broadcast may be added to the web site. In step 222, the system compiles a search and displays a list based upon a subscriber search inquiry input 217. In other words, the medical compliance system includes a web based search routine. This web based search routine may be contracted out to robust search engines such as YAHOO or ALTAVISTA.

Step 224 compiles, updates and maintains hyperlinks throughout the whole system. Output 219 provides hyperlinks for subscribers to outside sources. Step 226 broadcasts selected news items to subscriber news groups. The subscriber, when he or she initially signs up with the medical compliance program, may identify an interest in certain areas. The following Subscriber News Record provides some of these areas.

Subscriber News Record

subscriber name, e-mail address
news category (e.g., stroke, AIDS)
article category (e.g., VIAGRA, specific Rx)
subscriber requested items

Step 228 monitors input from the subscriber's input chat 227 and the subscriber's output chat 229. These inputs and outputs are chat rooms or news groups.

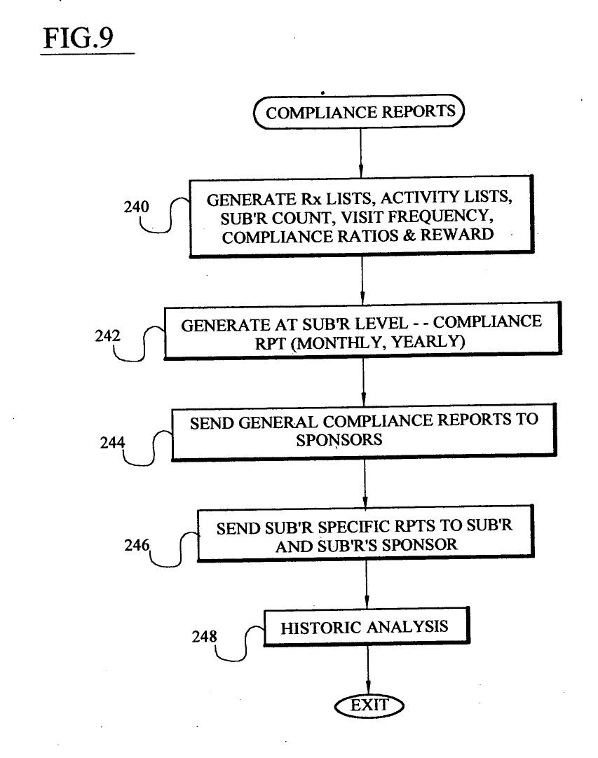

The compliance report process shown in FIG. 9 is part of a report generation system. Step 240 generates pharmaceutical use report, renewal of prescription data, activity list, subscriber count, frequency of visits at the site, medical compliance ratios, and benefit/reward ratios for the site. Step 242 generates at the subscriber level, that is, for each subscriber, an individual compliance report. This compliance report is generated periodically such as daily, weekly, monthly or yearly. Typically, monthly and yearly reports are most beneficial to the subscriber. Step 224 sends the general compliance reports to system sponsors. These system sponsors are discussed above in a System Sponsor Table. Step 246 sends specific reports to the subscriber and particular sponsors for the particular subscriber. For example, an employer may give a subscriber extra vacation days if the subscriber maintains a certain medical compliance. In order to confirm that the subscriber/employee is following medical protocol, the report generated in step 246 provides this confirmation report to the employer. Step 248 provides a historic analysis for the system's operator.

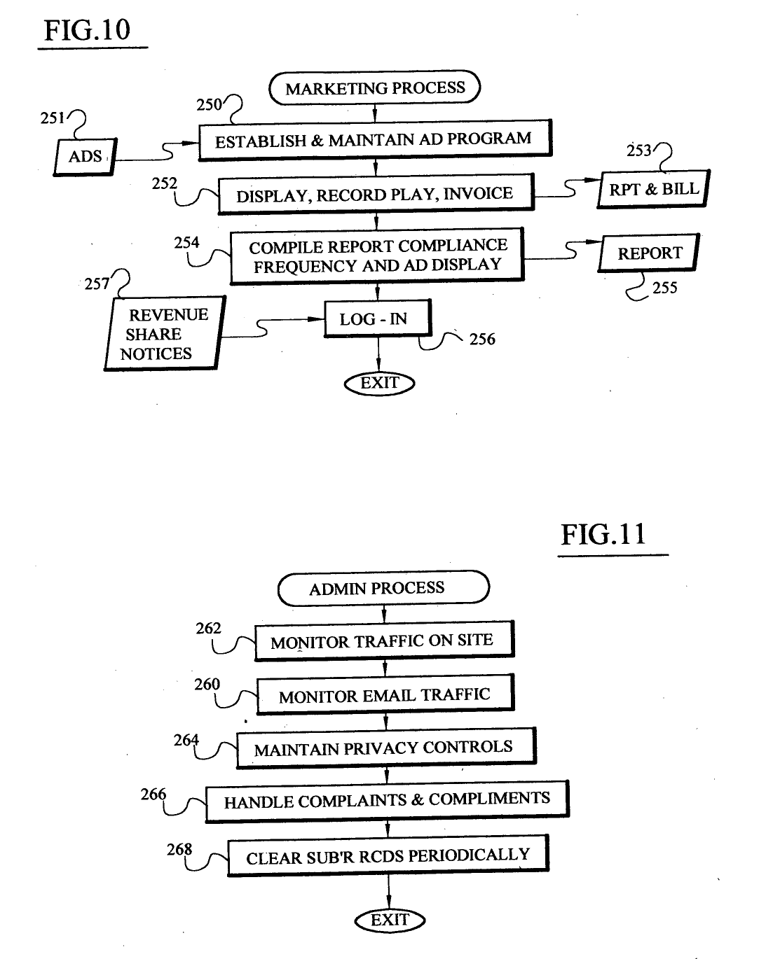

FIG. 10 shows a marketing process. Step 250 establishes and maintains the advertising program on the system. Ad input 251 enables the acceptance of electronic ads into the system. Ad content is an important feature of the present Internet compliance application system. Step 252 displays, records the display time and date and invoices the advertiser. The bill and report output 253 is a result of the generation of advertising reports and invoices. Step 254 compiles reports for medical compliance, frequency and displays. Reports are generated as report output 255. In step 256, a login procedure is noted whereby cooperating vendors share revenues with the system. Revenue share notices input 257 are data input into the accounting system in login step 256. It is well known that certain vendors pay a referral fee based on a percentage of goods sold at their sites if the subscriber is referred from a cooperating web site. Steps 256, 257 recognize this revenue sharing procedure. Typically, these revenue sharing vendors are not medical suppliers or drug stores.

FIG. 11 shows an administrative process. Step 260 monitors traffic on the site. Step 262 monitors e-mail traffic from the site and to the site. Step 264 maintains the privacy of the medical data and establishes controls and modifies those controls as necessary. Step 266 handles complaints and compliments for the system. Step 268 clears subscriber's records periodically based on non-use.

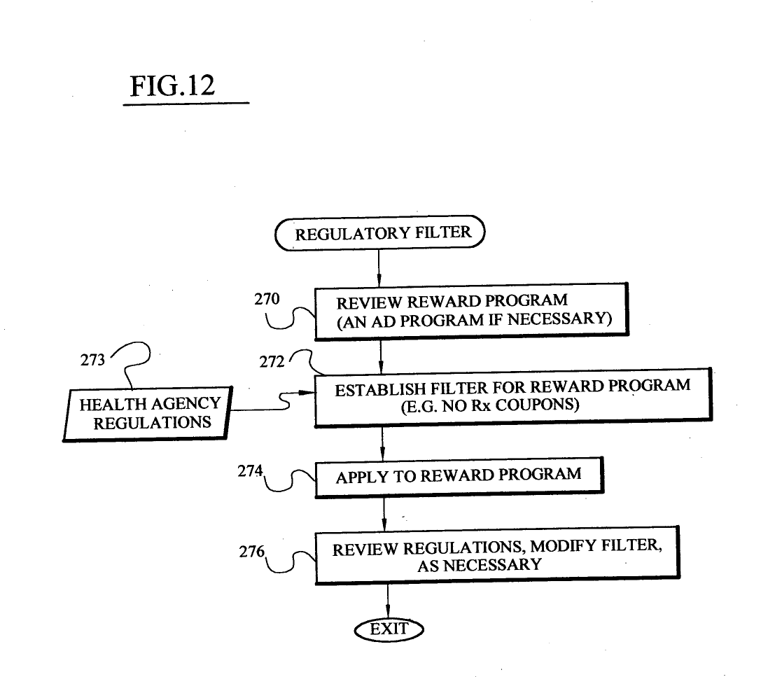

FIG. 12 is a regulatory filter process. Currently, there are a number of rules and legal regulations regarding coupon distribution and use from drug companies to patients, referral services by healthcare providers to other healthcare providers and suppliers and privacy regulations regarding medical records. Some of these rules are national in scope and other rules are regional, local or unique to a particular employer or identified subgroup of subscribers. The regulatory filter process recognizes that certain types of rewards cannot be provided to certain types of subscribers. Accordingly, if a certain award discussed herein is not available due to current regulations, the regulatory filter prohibits that reward from being issued to the subscriber. Step 270 recognizes that a review of the reward program is a necessary component of the present invention. A review of ad programs may also be necessary. Step 270 establishes a filter, either an administrative filter or an actual data filter, based upon input from health agency regulations 273. Step 274 applies the reward filter to the reward program currently in existence. Step 276 reviews regulations and, modifies the filter as necessary.

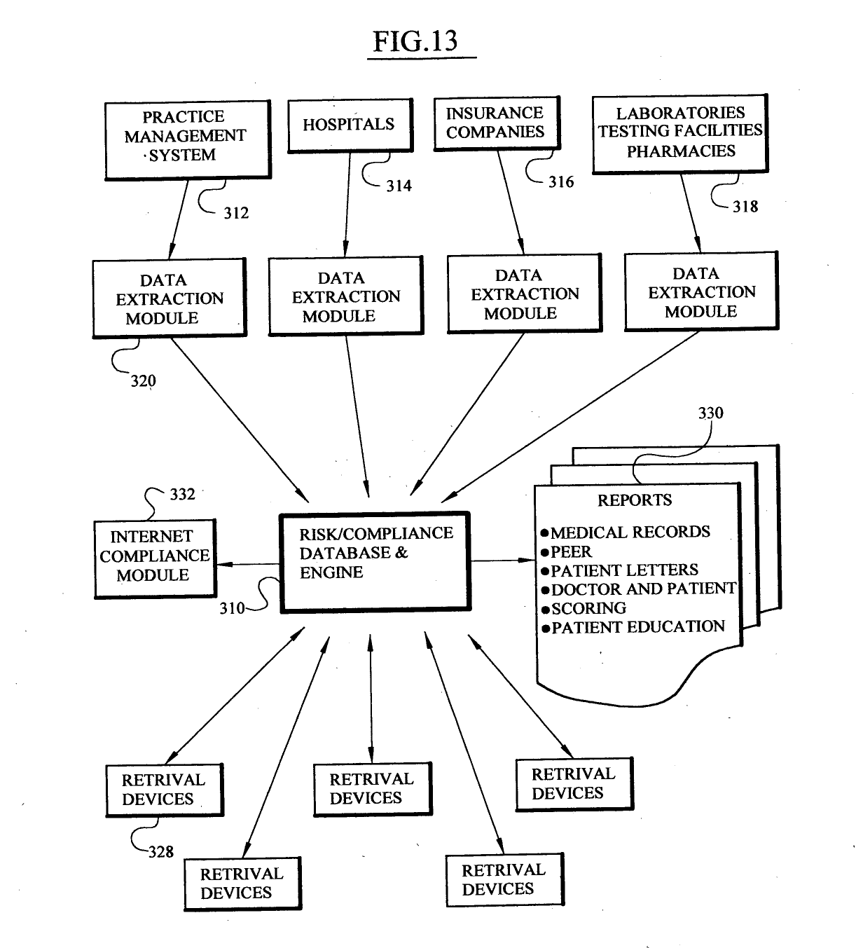

FIG. 13 diagrammatically illustrates a system diagram for the risk monitor and analysis process, method and system. Risk/compliance database and engine 310 accepts and obtains input for each patient, in a preferred embodiment, through a plurality of data extraction modules 320, each associated with data sources storing patient data, patient medical compliance plans, patient therapy and patient condition systems. For example, physicians typically utilize practice management system 312 (“PMS” 312) in the delivery of healthcare services to their patients. Hospitals 314 also provide medical compliance plans for individual patients. Insurance companies 316 and laboratories, testing facilities and pharmacies 318 also retain some information regarding medical compliance plans or regimens of treatment for patients. Data extraction modules 320 represent processes and systems which extract, on a patient by patient basis, medical compliance plans and patient data and regarding patient compliance with those plans. This information is obtained and stored in risk compliance database and engine 310.

In one application, PMS 312 is utilized to compile the risk compliance database and engine 310 such that when a patient returns to a physician's office on a second, third or follow-up visit, the doctor or other healthcare professional utilizes retrieval devices 328 (preferably, a highly portable laptop computer, personal data assistant PDA, or a PC at a patient intake location) to obtain current compliance data from the patient. A series of customized questions are presented to the patient.

Patient Question Table

Did you take your medications

id medications
note non-compliance event(s)
side effects

Did you go to Dr. X, clinic Y

frequency
favorable - not significant - not favorable
exercise - therapy
missed appointments
why (pull down menu, forgot, no car, illness)

Did you follow Dr.'s orders Yes- No - Maybe

display last orders

Lifestyle data input questions (weight, diet, exercise, smoking, alcohol,
stress, skin protection, wound care, personal care, back care)

The patient answers these questions and the healthcare professional enters the information from the patient indicative of whether the patient adhered to or complied with his or her respective medial compliance plan. Additionally, questions regarding the patient's lifestyle relating to weight, diet, exercise, smoking, alcohol, stress, skin protection, type of and degree of wound care, personal care and back care are also entered into the risk compliance database 310 by one of the retrieval devices 328. Other inquiries or patient compliance data maybe obtained. In order to motivate or increase patient compliance, the risk compliance engine 310 assesses and compares the patient data to a plurality of risk levels. A risk value is computed based on the previously entered medical compliance plans and other patient history as well as the currently entered patient data. Reports 330 are generated both at an individual patient level as well as for the plurality of patients. The risk value for a group of patients treated by a single doctor or for all patients for a group of doctors or an entire practice of doctors can be compiled. Further, this information regarding a patient's adherence or compliance with medical compliance plans can be used to generate in compliance module 332, various communication episodes such as e-mail to a particular patient, letters to a particular patient and telephone calls (either automated voice mail or live person presentations to the patient).

Importantly, the type and degree and frequency of communication episodes may be altered to reduce risk value both at an individual patient level as well as a total risk value for a plurality of patients. In other words, some patients may be motivated by an e-mail reminder to take medicines and to lose weight whereas other patients are better reminded by letters directed to their home regarding appointments, follow-up treatment with other clinics or pharmacies (element 318). Further, reporting the patient's risk value provides an educational component. The internet compliance modules 332 are discussed extensively earlier in connection with FIG. 2. Some current patient data may be obtained via the Internet. A reward system may be integrated with the risk monitor system. The following Sample Scoring Table provides an example of one method and system to assess and quantify the patient for his or her risk value. Other types of scoring systems may be utilized.

Sample Scoring Table

| | Weight |
|---|---|
| Adherence to Appointments | 4 |
| Adherence to Lab, Referrals and Testing | 6 |
| Medication | 4 |
| Lifestyle | 0.5 |
| Post Treatment Care | 4 |

| | Score |
|---|---|
| Appointments | |
| Missed 0 in last year | 0 |
| Missed 1 | 2 |
| Missed 2 or more | 5 |
| Referral/Testing | |
| Went to Appointment | 0 |
| Pending Visit | 1 |
| Did not Go | 10 |
| Medication | |
| Compliant | 0 |
| Moderately Compliant | 2 |
| Very Non-Compliant | 5 |
| No reported side-effects | 0 |
| Reported side-effect no medication change | 1 |
| Reported side-effect medication change | 3 |
| Post Treatment | |
| Following orders | 1 |
| Moderately following orders | 3 |
| Not following orders | 5 |

| Lifestyle/Consultations | Yes | No |
|---|---|---|
| Weight | 0 to 5 | 0 |
| Diet | 0 to 5 | 0 |
| Exercise | 0 to 5 | 0 |
| Smoking | 0 to 5 | 0 |
| Alcohol | 0 to 5 | 0 |
| Stress | 0 to 5 | 0 |
| Skin Protection | 0 to 5 | 0 |
| Wound Care | 0 to 5 | 0 |
| Personal Care | 0 to 5 | 0 |
| Back Care | 0 to 5 | 0 |
| Maximum Points | 137 | |

| | Scoring Scale |
|---|---|
| F level (High Risk) | 70 or higher |
| D level | 50 to 69 |
| C level (Moderate Risk) | 39 to 49 |
| B level | 10 to 29 |
| A level (Low Risk) | less than 10 |

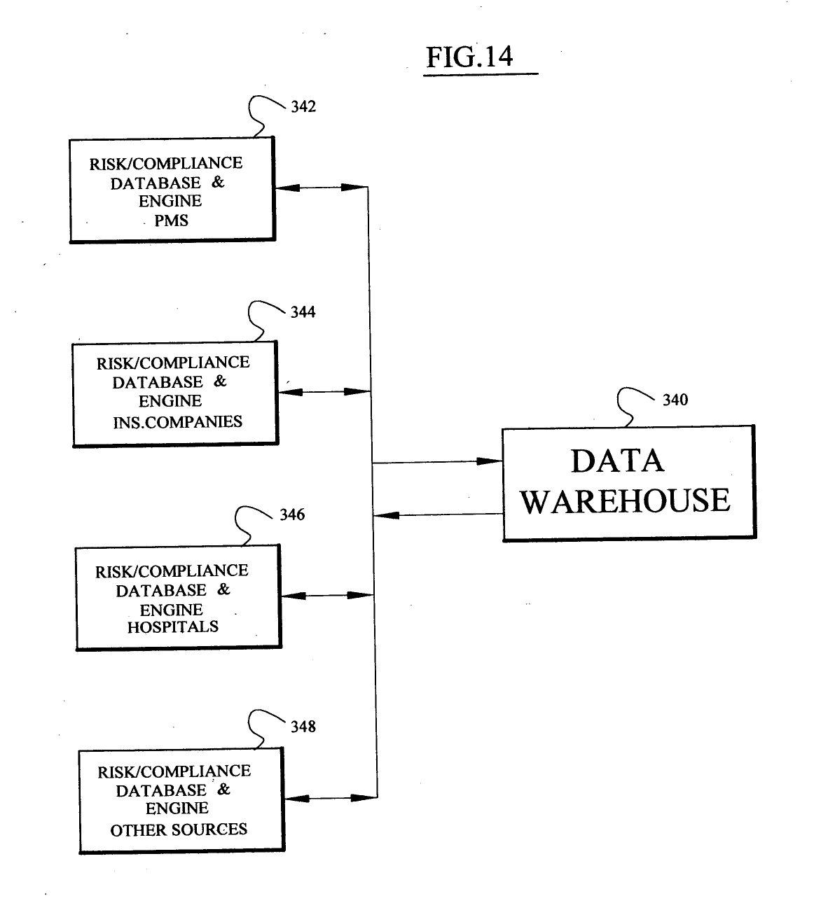

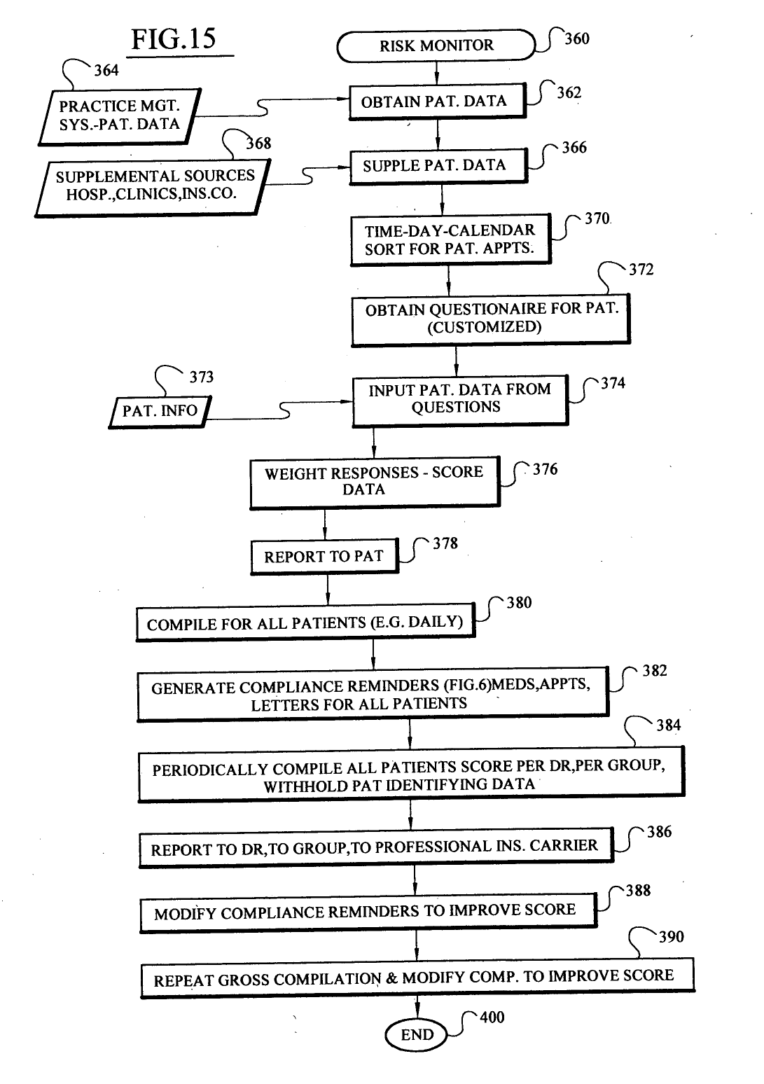

FIG. 14 diagrammatically illustrates another system diagram for the risk monitor system. In this exemplary system, data warehouse 340 maintains a large compendium of medical compliance plans for a plurality of patients and additional medical information and personal information for patients. Data is sent to and retrieved from data warehouse 340 by risk compliance database and engine 342 which preferably is integrated with practice management system PMS 312 (FIG. 13) at doctor's offices, the risk compliance database and engine at insurance companies 344, the database and engine at hospitals 346 and the risk compliance database and engine at other sources 348. By implementing the current risk monitor on a system wide basis as shown in FIG. 14, numerous communication episodes can be generated for a particular patient relating to medication, physical therapy, follow-ups with specialist, follow-up medical procedures, regular visits to the primary care physician, among other things. One important aspect of the present invention is the feedback system wherein the communication episodes with the patient are utilized to determine which communication episodes or modes best motivate the patient to follow his or her medical compliance plan. This feedback system adjusts or alters the communication episodes thereby continually reducing the risk value for that patient and, for a plurality of patients for a single doctor or group of doctors, to reduce the total risk value for that doctor as well as for the group of doctors. Professional insurance carriers for the doctor, healthcare professional and group may be interested in reducing risk values for groups of patients. For example, a patient that continually misses his or her appointment, has a higher degree of risk both to himself at an individual level as well as a higher degree of risk for the healthcare providers. Failure to follow medical compliance plans results in a poorer quality of life and health which in turn increases the potential for liability to the healthcare provider. Simply put, people who do not recover from illnesses and accidents tend to sue healthcare providers. If compliance modules 332 (FIG. 13) are effectively utilized in conjunction with the risk monitor, the healthcare delivery system can be improved because patients will be motivated to reduce their risk by following the medical compliance plan established for the patient by the healthcare system. FIG. 14 graphically illustrates the integration of various healthcare practices into the risk compliance methodology described herein.

FIG. 15 diagrammatically illustrates a flow chart of one embodiment of the risk monitor. It is important to note that other computer implementations may be utilized and the order of the various steps or functions in FIG. 15 ( and the function's task) can be changed to provide a more effective and efficient risk monitor system. In step 362, data is obtained for the patient. Input 364 shows that practice management system supplies patient data into the risk monitor program 360. Step 366 supplements the patient data in the risk monitor program with input from supplemental sources such as hospitals, clinics and insurance companies via input 368. Step 370 sorts all the patient data for a day and a time on a calendar basis. Step 372 creates and obtains a questionnaire for each particular patient. Some examples of the questions are shown earlier in the Patient Question Table. The Patient Question Table should be modified for each particular healthcare provider. For example, an obstetrician may be interested and may have a patient questionnaire requesting information regarding whether or not the patient has taken her vitamins on a daily basis and asking how many salty foods she had eaten in the past day, week and four-week period. In contrast, a podiatrist's questionnaire may seek information regarding whether a person's foot hurts, whether the person has engaged in physical therapy or activity such as walking, how often the patient walks, the amount of time the patient walks, etc.

Step 374 obtains current compliance and lifestyle information from the patient based on the questionnaire developed in step 372. Input step 373 indicates that the patient supplies this data. Step 376 rates or weighs the responses and accesses the responses and generates a score or risk value data. The Sample Scoring Table set forth above provides some general indication regarding the type of scoring a primary healthcare physician's office may obtain. Other types of scoring formulas may be provided. Step 378 generates a report to the patient indicating the risk value for the patient based upon a range of risk values. As shown in the Sample Scoring Table above, scores higher than 70 (out of a maximum level of 137) represent patient at high risk level F, patients at moderate risk have a score from 30-38 (level C) and low risk patients at level A have a score less than 10. Other scoring systems may be utilized. This risk value is reported to the patient as shown in FIG. 13 as reports 330. Also, an annotation is made in the patient's electronic records. Step 380 compiles the information for all patients on a daily basis in order to enable the healthcare professional to retrieve and gather new patient data based upon those questionnaires. Preferably, this occurs with retrieval devices 328. Step 382 generates compliance reminders for other patients (see FIG. 6) regarding medications, appointments, and letters for patients in order to motivate those patients to adhere to the medical compliance plan. These efforts represent communication episodes. Step 384 periodically compiles all the patient risk values on a per doctor, per group or per practice level and withholds specific patient identifying data. Step 386 reports the total risk value (and total patient count, without identifying the patient) for the doctor, the total risk value for the group of doctors ( reported to managers of the group) as well as to professional insurance carriers. Lower total risk values may result in low insurance rates for the healthcare professionals. Step 388 modifies the compliance reminders and the communication episodes to improve the risk value for a particular patient and a group of patients. Step 390 repeats the gross compilation in step 384 and the modification of communication episodes in step 388 to improve the total risk values for the entire healthcare system. It should be noted that the system may utilize a reward system to reward patients to better adhere to medical compliance plans. This feature is discussed above in connection with FIG. 2, among others.

The claims appended hereto are meant to cover modifications and changes within the scope and spirit of the present invention.

1. A computer based method for assessing risk based upon monitoring medical compliance by a plurality of patients with a corresponding plurality of medical compliance plans comprising:
inputting information representing said plurality of medical compliance plans for said plurality of patients;
displaying a corresponding medical compliance plan associated with a respective patient;
accepting a corresponding input from said respective patient indicative of compliance by said respective patient with said corresponding medical compliance plan;
assessing said corresponding input from said respective patient indicative of compliance and assigning a corresponding risk value thereto based upon a range of risk values for various degrees of compliance;
repeating inputting, displaying, accepting and assessing for said plurality of patients and compiling a plurality of risk values;
reporting said corresponding risk value to said respective patient, individually reporting risk value to said plurality of patients and compiling and reporting a total risk value for said plurality of patients.

2. A computer based method as claimed in claim 1 including accepting a corresponding input from said respective patient indicative of said respective patient's lifestyle, assessing said corresponding input from said respective patient indicative of lifestyle and assigning a corresponding risk value thereto based upon a range of risk values for various degrees of lifestyle, repeating accepting lifestyle input, assessing and assigning for said plurality of patients and reporting said risk value individually and said total risk value.

3. A computer based method as claimed in claim 2 including generating communication episodes for said plurality of patients responsive to corresponding medical compliance plans associated with said respective patients as a reminder for said corresponding medical compliance plans, and altering said communication episodes to reduce said individually reported risk value and said total risk value.

4. A computer based method as claimed in claim 3 including establishing a predetermined reward system based upon medical compliance levels for each of said plurality of medical compliance plans; and issuing a reward to said respective patient based upon said input indicative of compliance.

5. A computer based method as claimed in claim 3 including displaying a corresponding medical compliance plan template on a respective patient's computer.

6. A computer based method as claimed in claim 5 including displaying on said respective of patient computer a portion of said predetermined reward system and related medical compliance levels for an exemplary group of rewards and medical compliance plans.

7. A computer based method as claimed in claim 6 wherein said medical compliance plans include action and time based frequency data and the displaying said exemplary group of rewards additionally displays rewards, action and time to said respective patient.

8. A computer based method as claimed in claim 7 wherein the displaying said exemplary group of rewards occurs via a web site.

9. A computer based method as claimed in claim 3 wherein said accepting the input indicative of compliance occurs substantially concurrently with the displaying said corresponding medical compliance plan associated with said respective patient.

10. A computer based method as claimed in claim 4 wherein issuing said reward to said respective patient includes compiling data representing a plurality of rewards to said plurality of patients.

11. A computer based method as claimed in claim 10 wherein said reward is one of a plurality of coupons, frequent flyer miles, vouchers for goods or services, and the method includes electronically delivering said reward to said respective patient's computer.

12. A computer based method as claimed in claim 1 wherein said medical compliance plan is one or more from the group of a systematic treatment plan which includes the intake of prescription drugs, a systematic physical exercise routine, a systematic physical therapy routine.

13. A computer based method as claimed in claim 3 wherein said communication episodes include one communication episode from the group of episodes including a telephone call, an email, and a written correspondence, said communication episode directed to said respective patients for said corresponding medical compliance plans.

14. A computer readable medium containing programming instructions for assessing risk based upon monitoring medical compliance by a plurality of patients with a corresponding plurality of medical compliance plans, the programming instructions comprising:
inputting information representing said plurality of medical compliance plans for said plurality of patients;
displaying a corresponding medical compliance plan associated with a respective patient;
accepting a corresponding input from said respective patient indicative of compliance by said respective patient with said corresponding medical compliance plan;
assessing said corresponding input from said respective patient indicative of compliance and assigning a corresponding risk value thereto based upon a range of risk values for various degrees of compliance;
repeating inputting, displaying, accepting and assessing for said plurality of patients and compiling a plurality of risk values;
reporting said corresponding risk value to said respective patient, individually reporting risk value to said plurality of patients and compiling and reporting a total risk value for said plurality of patients.

15. A computer readable medium as claimed in claim 14 including accepting a corresponding input from said respective patient indicative of said respective patient's lifestyle, assessing said corresponding input from said respective patient indicative of lifestyle and assigning a corresponding risk value thereto based upon a range of risk values for various degrees of lifestyle, repeating accepting lifestyle input, assessing and assigning for said plurality of patients and reporting said risk value individually and as said total risk value.

16. A computer readable medium as claimed in claim 15 including generating communication episodes for said plurality of patients responsive to corresponding medical compliance plans associated with said respective patients as a reminder for said corresponding medical compliance plans, and altering said communication episodes to reduce said individually reported risk value and said total risk value.

17. A computer readable medium as claimed in claim 16 including establishing a predetermined reward system based upon medical compliance levels for each of said plurality of medical compliance plans;
issuing a reward to said respective patient based upon said input indicative of compliance.

18. A computer readable medium as claimed in claim 16 including displaying a medical compliance plan template on a respective patient's computer.

19. A computer readable medium as claimed in claim 18 including of displaying on said respective of patient computer a portion of said predetermined reward system and related medical compliance levels for an exemplary group of rewards and medical compliance plans.

20. A computer readable medium as claimed in claim 19 wherein said medical compliance plans include action and time based frequency data and the displaying said exemplary group of rewards additionally displays rewards, action and time to said respective patient.

21. A computer readable medium as claimed in claim 20 wherein displaying said exemplary group of rewards occurs via a web site.

22. A computer readable medium as claimed in claim 16 wherein accepting the input indicative of compliance occurs substantially concurrently with displaying said corresponding medical compliance plan associated with said respective patient.

23. A computer readable medium as claimed in claim 17 wherein issuing said reward to said respective patient includes compiling data representing a plurality of rewards to said plurality of patients.

24. A computer readable medium as claimed in claim 23 wherein said reward is one of a plurality of coupons, frequent flyer miles, vouchers for goods or services, and the method includes the step of electronically delivering said reward to said respective patient's computer.

25. A computer readable medium as claimed in claim 14 wherein said medical compliance plan is one or more from the group of a systematic treatment plan which includes the intake of prescription drugs, a systematic physical exercise routine, a systematic physical therapy routine.

26. A computer readable medium as claimed in claim 16 wherein said communication episodes include one communication episode form the group of episodes including a telephone call, an email, and a written correspondence, said communication episode directed to said respective patients for said corresponding medical compliance plans.

27. A computer system assessing risk based upon monitoring medical compliance by a plurality of patients with a corresponding plurality of medical compliance plans, the system comprising:
means for inputting information representing said plurality of medical compliance plans for said plurality of patients;
means for displaying a corresponding medical compliance plan associated with a respective patient;
means for accepting a corresponding input from said respective patient indicative of compliance by said respective patient with corresponding said medical compliance plan;
means for assessing said corresponding input from said respective patient indicative of compliance and assigning a corresponding risk value thereto based upon a range of risk values for various degrees of compliance;
means for compiling a plurality of risk values for said plurality of patients;
report generator for reporting said corresponding risk value to said respective patient and individually a reporting risk value to said plurality of patients and means for compiling and reporting a total risk value for said plurality of patients.

28. A computer system as claimed in claim 27 including means for accepting a corresponding input from said respective patient indicative of said respective patient's lifestyle, means for assessing said corresponding input from said respective patient indicative of lifestyle and means for assigning a corresponding risk value thereto based upon a range of risk values for various degrees of lifestyle, and means for reporting said risk value individually and said total risk value.

29. A computer system as claimed in claim 28 including means for generating communication episodes for said plurality of patients responsive to corresponding medical compliance plans associated with said respective patients as a reminder for corresponding said medical compliance plans, and means for altering said communication episodes to reduce said individually reported risk value and said total risk value.

30. A computer system as claimed in claim 29 including means for establishing a predetermined reward system based upon medical compliance levels for each of said plurality of medical compliance plans; and means for issuing a reward to said respective patient based upon said input indicative of compliance.

31. A computer system as claimed in claim 30 including a display of a medical compliance plan template on a respective patient's computer.

32. A computer system as claimed in claim 31 including a display on said respective of patient computer of a portion of said predetermined reward system and related medical compliance levels for an exemplary group of rewards and medical compliance plans.

33. A computer system as claimed in claim 32 wherein said medical compliance plans include action and time based frequency data and displaying said exemplary group of rewards additionally displays rewards, action and time to said respective patient.

34. A computer system as claimed in claim 33 wherein the display said exemplary group of rewards occurs via a web site.

35. A computer system as claimed in claim 34 wherein acceptance of the input indicative of compliance occurs substantially concurrently with the display said corresponding medical compliance plan associated with said respective patient.

36. A computer system as claimed in claim 35 wherein said means for issuing said reward to said respective patient includes means for compiling data representing a plurality of rewards to said plurality of patients.

37. A computer system as claimed in claim 36 wherein said reward is one of a plurality of coupons, frequent flyer miles, vouchers for goods or services, and the system includes means for electronically delivering said reward to said respective patient's computer.

38. A computer system as claimed in claim 29 wherein said medical compliance plan is one or more from the group of a systematic treatment plan which includes the intake of prescription drugs, a systematic physical exercise routine, a systematic physical therapy routine.

39. A computer system as claimed in claim 38 wherein said communication episodes include one communication episode from the group of episodes including a telephone call, an email, and a written correspondence, said communication episode directed to said respective patient for said corresponding medical compliance plans.
